(19) United States
(12) Patent Application Publication
(10) Pub. No.: US 2003/0142974 A1
(43) Pub. Date: Jul. 31, 2003

(54) Moving mechanism of camera barrier

(75) Inventor: Minoru Tanabe, Taichung (TW)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JO)

(21) Appl. No.: 10/323,674

(22) Filed: Dec. 20, 2002

(30) Foreign Application Priority Data
Jan. 31, 2002 (JP) 2002-023596

(51) Int. Cl. G03B 17/00

(52) U.S. Cl. 396/448

(57) ABSTRACT

A barrier mechanism of a camera is disclosed, which comprises a camera body, a barrier member being movable between a closed position covering a lens located in the front of the camera body and an open position exposing the lens, a holding mechanism for holding the barrier member slidably between the closed position and the open position, a guide rail member disposed in the camera body and extending in a sliding direction of the barrier member for guiding the barrier member, and an engaging member disposed in the barrier member to be brought into engagement with the guide rail member so as to suppress the barrier backlash.

### BACKGROUND OF THE INVENTION

1. Field of the Invention

The present invention relates to a moving mechanism of a camera barrier for covering a lens barrel.

2. Description of the Related Art

In order to protect a camera lens, various barrier mechanisms sliding between positions covering and exposing a lens barrel along the camera front have been proposed. As typical one, there are proposed and commercialized, in which a camera is provided with concave guide rails formed in the front and on the top and bottom surfaces thereof while a barrier is provided with engaging portions to be brought into engagement with the guide rails, so that the barrier can slide along the guide rails.

In a camera with a sliding barrier, proposed in Japanese Patent Laid-Open No. 2000-111989, a camera is also provided with concave guide rails formed on the top and bottom surfaces thereof while a barrier is provided with engaging portions to be brought into engagement with the guide rails, so that the barrier can slide along the guide rails. In addition, the bottom surface of the barrier is provide with a guide groove formed at the center while the front surface of a camera body provided with a convex portion to be brought into engagement with the guide groove, so that the barrier is guided thereby when moving while being prevented from coming off the camera body even when being pushed from front and deflected.

However, in these barrier mechanisms, there have been problems that since the guide rails are exposed on the top and bottom surfaces of the camera, a design is impaired and the barrier may not smoothly move when dust or sand comes into the guide rails. Furthermore, although it is enough to cover a lens, finder window, and AF window with the barrier, the barrier must vertically bridge the top and bottom guide rails at least while the length in the sliding direction requires more than a predetermined engagement length for stable sliding, so that the barrier must have a substantial rectangular shape, limiting the degree of freedom in design.

Whereas the assignee of this application has a mechanism with the brand name “Auto Boy Luna” (“Super Shot Prima” in U.S.), in which barrier holding means is arranged only in the range, in which the barrier in the full closed position overlaps that in the full open position, so that the guide rails are not exposed. This is disclosed in U.S. Pat. No. 5,913,089. On the back surface of the barrier, two upper and lower rack gears are arranged extending in the barrier sliding direction, so that a rotational backlash about a barrier axis parallel with the lens optical axis is suppressed by arranging two gears mating with the rack gears in the camera body. In such a structure, the guide rails are not exposed and limitations in a barrier shape are reduced, increasing the degree of freedom in design. However, by such a mechanism, the barrier holding portions are insufficient, so that the backlash and looseness of end portions of the barrier are difficult to be suppressed. Therefore, in the full open position, in order to hold the barrier open end, the barrier is provided with a convex portion while the camera body is provided with a concave portion to be brought into engagement with the convex portion. However, during moving of the barrier, the holding structure with convex and concave portions is not provided, so that the backlash and looseness cannot be suppressed.

### SUMMARY OF THE INVENTION

In view of the problems mentioned above, it is an object of the present invention to provide a camera barrier moving mechanism capable of suppressing the backlash and looseness of the barrier without impairing camera design while exposure of guide rails is reduced to the minimum.

A barrier mechanism of a camera according to the present invention comprises a camera body; a barrier member being movable between a closed position covering a lens located in the front of the camera body and an open position exposing the lens; a holding mechanism for holding the barrier member slidably between the closed position and the open position; a guide rail member disposed in the camera body and extending in a sliding direction of the barrier member for guiding the barrier member; and an engaging member disposed in the barrier member to be brought into engagement with the guide rail member.

Preferably, the holding mechanism comprises a guide plate disposed on the back surface of the barrier member and a holding member disposed in the camera body for slidably holding the barrier member by engaging with the guide plate.

Preferably, the holding member disposed in the camera body is located at a position covered with the barrier member even when the barrier member is positioned at any one of the closed position and the open position.

Preferably, the engaging member is disposed on the back surface of the barrier member and comprises a hook having a bent portion while the guide rail member having a slit groove to be brought into engagement with the bent portion of the hook.

Preferably, the holding mechanism further comprises a gear disposed in the camera body and a rack disposed in the barrier member to be mated with the gear.

Further objects, features and advantages of the present invention will become apparent from the following description of the preferred embodiments with reference to the attached drawings.

### BRIEF DESCRIPTION OF THE DRAWINGS

FIG. 1 is a front view of a camera in a barrier closed state.

FIG. 2 is a front view of the camera in a barrier open state.

FIG. 3 is an assembly view of a barrier 7.

FIG. 4 is a perspective view of the barrier 7 viewed from a camera body 1.

FIG. 5 is a drawing showing a state that the barrier 7 is attached to the camera body 1 (barrier closed).

FIG. 6 is a drawing showing a state that the barrier 7 is attached to the camera body 1 (barrier open).

FIG. 7 is a sectional view of the barrier 7 at the line A-A of FIG. 6.

FIG. 8 is a sectional view of the barrier 7 at the line B-B of FIG. 6.

FIGS. 9A and 9B are sectional views of the barrier 7 at the line C-C of FIG. 6; FIG. 9A shows the barrier closed state and FIG. 9B shows the barrier open state.

FIG. 10 is a partial longitudinal sectional view of the camera at the position of closed barrier.

FIG. 11 is a detailed drawing showing the engagement between a concave portion 10c and a claw 78b.

### DESCRIPTION OF THE PREFERRED EMBODIMENTS

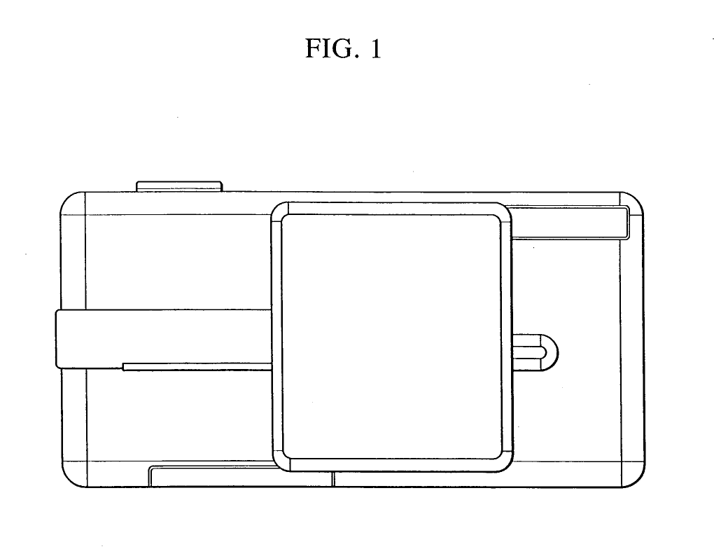

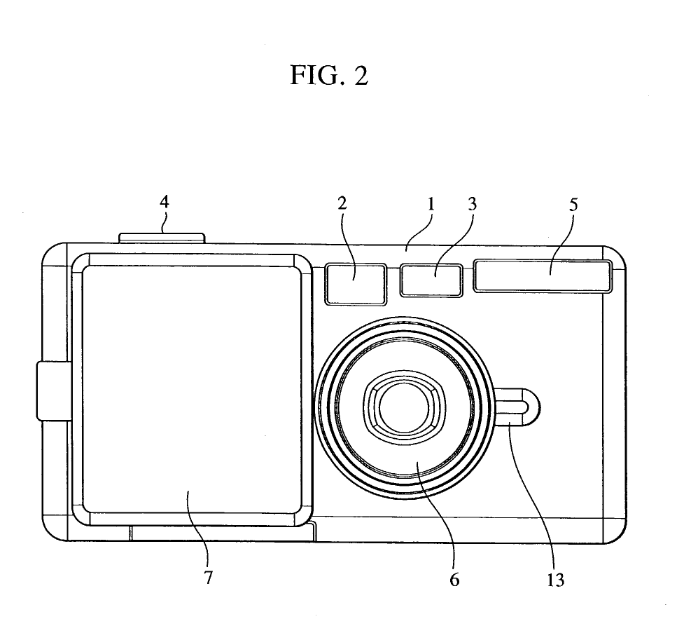

An embodiment according to the present invention will be described below with reference to the drawings. FIGS. 1 and 2 are front views of a camera showing the embodiment of the present invention; FIG. 1 shows a state of the closed barrier; FIG. 2 shows a state of the open barrier.

Numeral 6 denotes a lens barrel, and a camera body 1 is provided with a cablerelease button 4 arranged on the top surface and a finder object window 2, AF (auto focus) receiver 3, and electric flash emitting part 5, which are arranged on the front face the camera body 1. Numeral 7 denotes a barrier. As shown in the drawings, in the closed state of the barrier 7, the barrier 7 covers the lens barrel 6, finder object window 2, AF receiver 3, and part of the electric flash emitting part 5 so as to serve in protecting these parts. During using the camera, as shown in FIG. 2, a camera power supply (not shown) is turned on by sliding the barrier 7 toward a camera grip, so that the lens barrel 6 is protruded to a photographable position from the retracted position of the lens barrel.

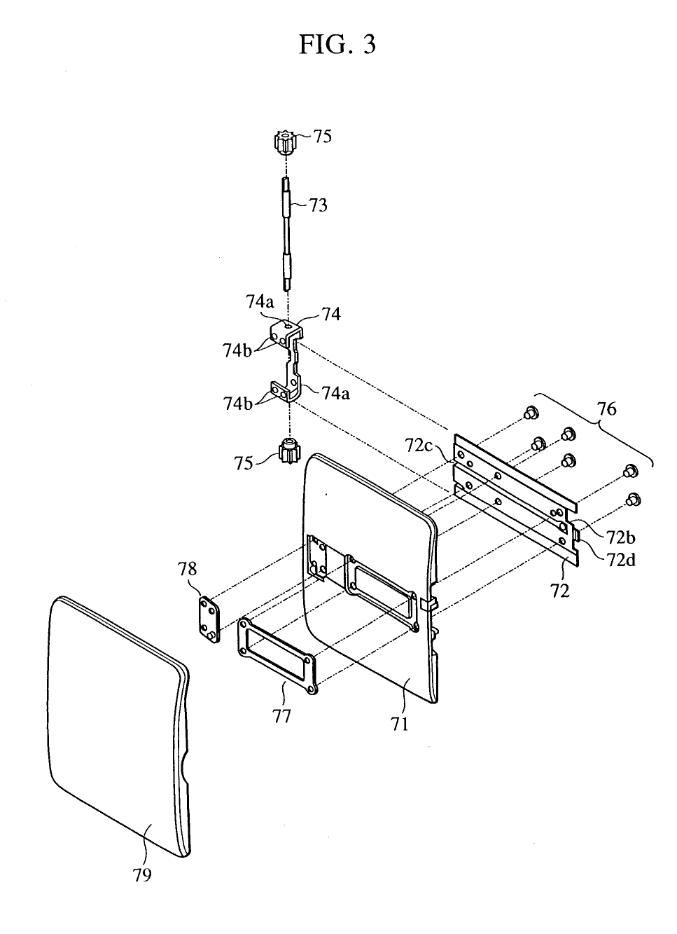

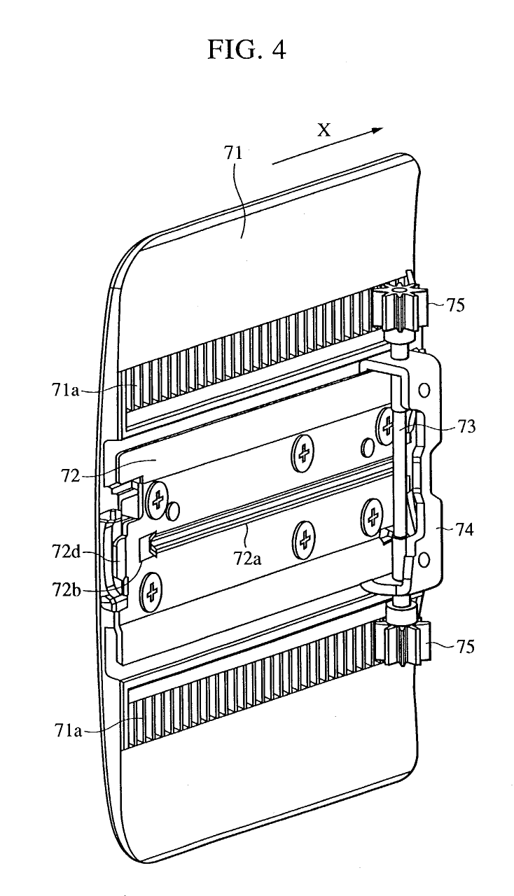

Next, a structure of the barrier 7 will be described with reference to FIGS. 3 and 4. FIG. 3 is an assembly view of the barrier 7; FIG. 4 is a perspective view thereof viewed from the camera body 1. Referring to FIGS. 3 and 4, on the back surface of a barrier body 71, a guide plate 72 is attached with screws 76. The screws 76 penetrate the barrier body 71 so as to be fastened with female screws provided in a mounting plate 77 and a hook 78. The guide plate 72, being a pressed thin-metallic plate, has a V-shaped groove 72a formed at the center extending in the barrier shifting direction, and both ends of the groove 72a are provided with a square hole 72b and a notch 72c, respectively. A cover 79 formed of a metallic-thin plate is bonded on the front surface of the barrier body 71.

A holding member 74 is fixed to the camera body 1 so as to slide the guide plate 72 in the sliding direction of the barrier 7. The top and bottom ends of the holding member 74 are provided with U-shaped bent portions, which are attached and sandwiched between the guide plate 72 and the barrier body 71 with appropriate clearances therebetween. A gear shaft 73 passing through holes 74a formed at the top and bottom ends of the holding member 74 has gears 75 attached to both ends. The gears 75 are slightly press-fitted to the gear shaft 73 with a D-cut hole and shaft so as to be integrally rotated with the gear shaft 73. A pair of the gears 75, as shown in FIG. 4, in an attached state to the barrier body 71, are mated with a pair of rack gears 71a provided in the barrier body 71. As mentioned above, there are appropriate clearances between the holding member 74, the barrier body 71, and the guide plate (rail member) 72, the barrier can be guided movably in the X direction in FIG. 4. During the moving, the gears 75 are continuously engaged with the rack gears 71a. By this engagement, the holding member 74 can move keeping its position without inclination relative to the barrier body 71.

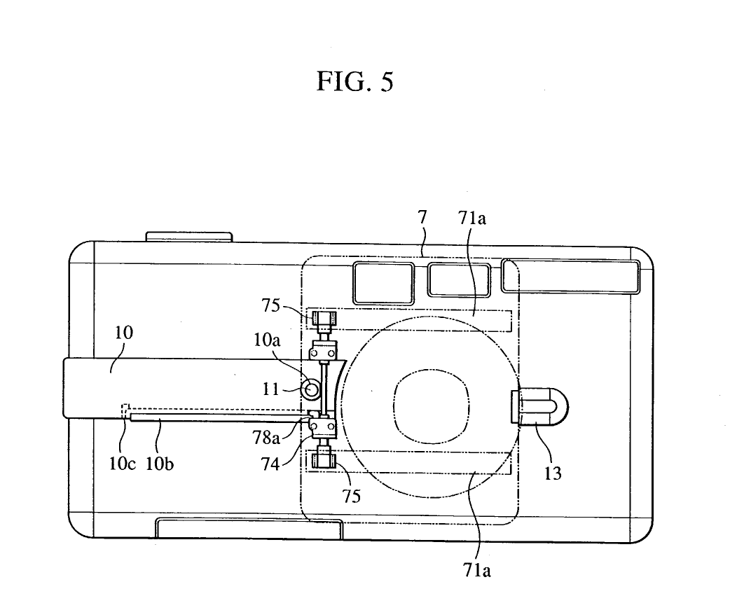

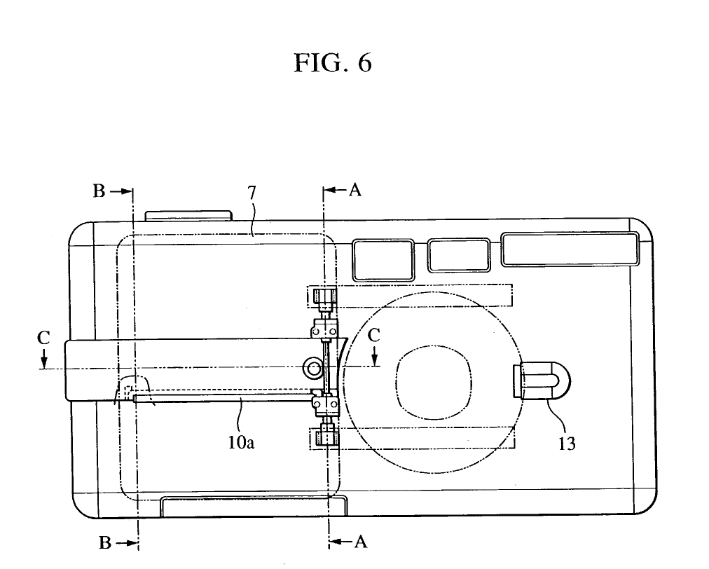

Next, a state of the barrier 7 attached to the camera body 1 will be described with reference to FIGS. 5 and 6.

FIG. 5 shows a state of the closed barrier 7; FIG. 6 shows a state of the open barrier 7. As shown in the drawings, the holding member 74 is positioned in the camera body 1 on the barrier opening side relative to the lens barrel 6, and fixed with female screws from the rear side of the camera body 1, so that the holding member 74 is always located at a position hidden by the back surface of the barrier 7 regardless of the position of the barrier 7.

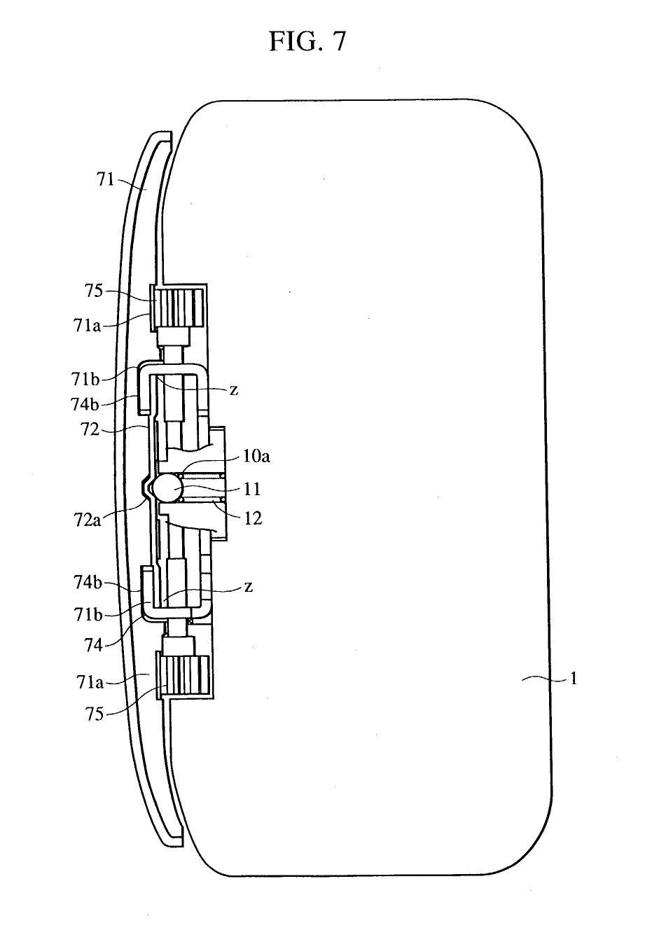

A click ball 11 is assembled into a hole formed in the guide rail 10. This state is shown in FIG. 7, which is a sectional view at the line A-A of FIG. 6 showing a halfway of the barrier shifting. As shown in FIG. 7, the click ball 11 is elastically urged in contact with the V-shaped groove 72a of the holding member 74 from the camera body 1 with a spring 12. As shown in the drawings, the click ball 11 comes in contact with the V-shaped groove 72a at two upper and lower points substantially symmetrically located about its center. Since the guide plate 72 has slight clearances relative to the holding member 74 in the vertical directions, the position of the guide plate 72 in the vertical directions is restricted by the contact between the click ball 11 and the V-shaped groove 72a.

From this state, even when the barrier 7 is pushed upward or downward, the barrier 7 cannot rattle as long as the force of the spring 12 is sufficiently large. Granted that the barrier 7 is moved, it can return to the two upper and lower contact points by the force of the spring 12. Even the force of the spring 12 is large, the holding member 74 is located close to the click ball 11 and the guide plate 72 is made of a metallic plate, so that the guide plate 72 cannot be deflected by the force of the spring 12 and the barrier 7 also cannot warp and loosen along therewith.

As described above, there is an appropriate clearance Z between the holding member 74 and the guide plate 72 in the vertical directions, so that during the barrier shifting, the friction is produced only in the front and rear direction of the camera and between rail surfaces 71b of the barrier body 1 and embosses 74b of the holding member 74 or in the back surface thereof and between the holding member 74 and the guide plate 72, thereby extremely reducing the contact area and resulting in a small frictional force. Contact between the click ball 11 and the guide plate 72 is rolling, enabling smooth operation.

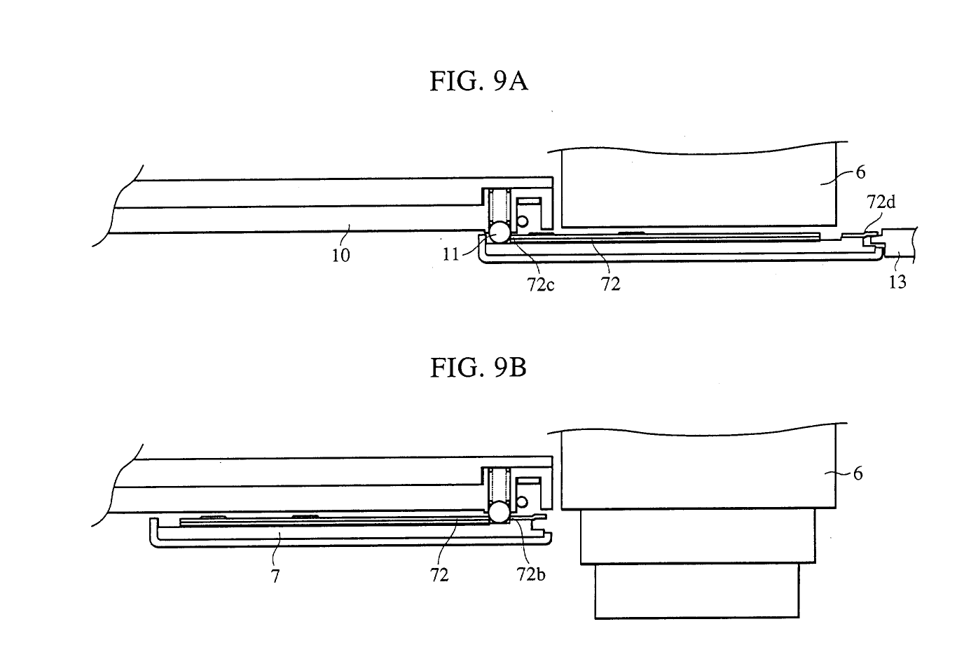

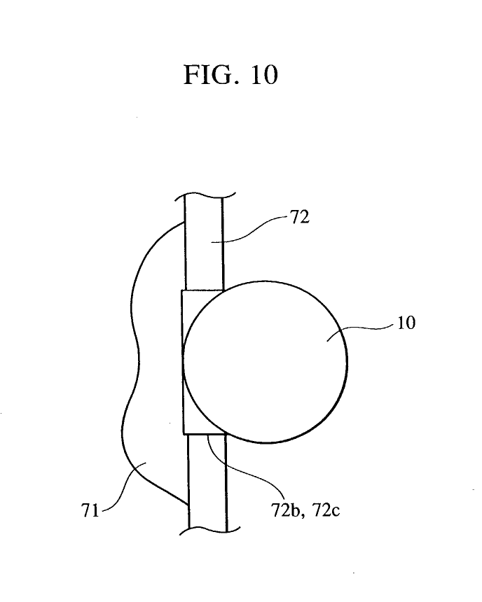

Next, the operation of the click ball 11 at open and closed positions of the barrier 7 will be described with reference to FIGS. 9A to 10. FIGS. 9A and 9B are sectional views at the line C-C of FIG. 6; FIG. 9A shows the closed position of the barrier 7; and FIG. 9B shows the open position thereof. At the closed position shown in FIG. 9A, a claw 72d formed at the end of the guide plate 72 pulls in a barrier holding member 13 disposed on the camera body so that the looseness of an end portion of the barrier 7 in the barrel side is suppressed. As shown in the drawing, at the closed position of the barrier 7, the click ball 11 falls in the notch 72c of the guide plate 72 so as to restrict the barrier shifting in the opening direction.

At the open position shown in FIG. 9B, the claw 72d also pulls in the square hole 72b so as to restrict the barrier shifting in the closing direction. At the respective positions, if the barrier 7 is operated in the sliding direction, the spring 12 is compressed and the click ball 11 runs on the V-shaped groove 72a, enabling the sliding.

FIG. 10 shows a longitudinal section of the camera at open and closed positions of the barrier 7. As shown in the drawing, when the click ball 11 pulls in the notch 72c and the square hole 72b, the click ball 11 comes contact at the upper and lower two points in the same way as in the barrier 7 during shifting shown in FIG. 7, so that the backlash of the barrier 7 in the vertical directions can be eliminated.

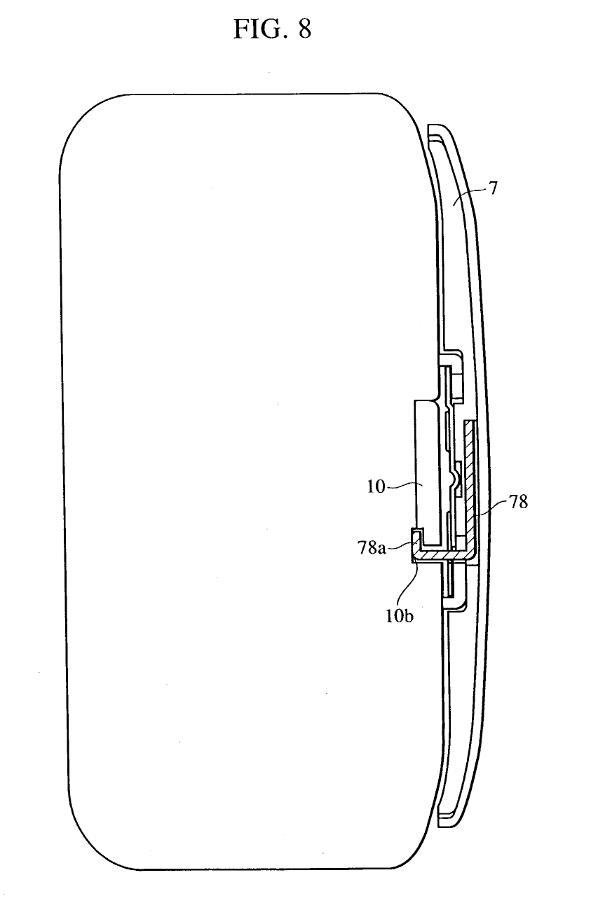

Next, the relationship between the hook 78 and the guide rail 10 will be described with reference to FIG. 8. FIG. 8 is a sectional view at the line B-B of FIG. 6. As shown in the drawing, a U-shaped bent portion 78a of the hook 78 is brought into engagement with an L-shaped slit 10b disposed between the guide rail 10 and the camera body 1.

The barrier 7 is held by the holding member 74 movably in the guiding direction; however, the lateral width of the holding member 74 must fall within the range that the holding member 74 is always hidden regardless of the position of the barrier 7, so that the width cannot be large enough. Accordingly, during the shifting of the barrier 7, at an end portion of the barrier 7, a stagger is produced in the back and forth direction of the camera, which could not be suppressed only by the holding member 74. However, the engagement between the hook 78 and the slit 10b of the guide rail 10 enables the stagger to be suppressed. Also, since the click ball 11 is located in the holding member 74 in the barrier open side, the barrier open-side end is urged by the spring 12 away from the camera body 1; however, this stagger is suppressed by the engagement between the hook 78 and the slit 10b of the guide rail 10. On the other hand, the barrier barrel-side end is urged toward the camera body 1 oppositely to the barrier open-side end, so that the barrier 7 cannot be separated from the camera body 1 by the sliding operation.

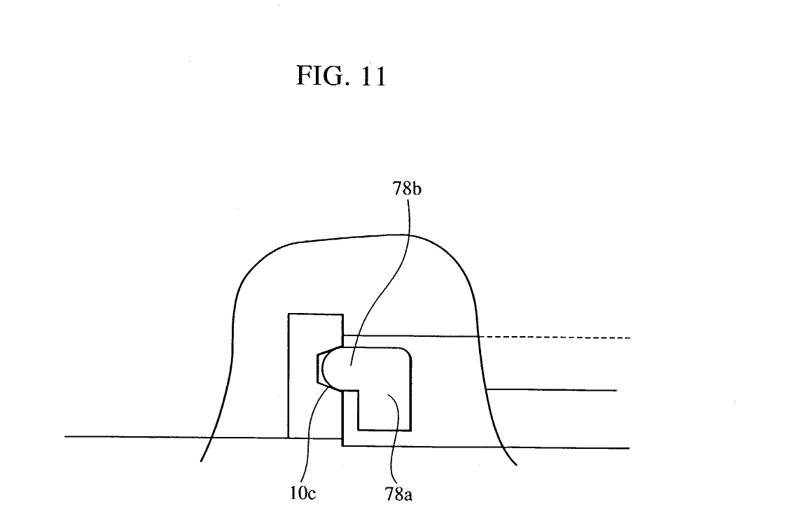

Furthermore, at an open-side end of the slit 10b, a concave portion 10c is formed. The detail thereof is shown in FIG. 11. On the other hand, at a barrier-side end of the bent portion 78a of the hook 78, a claw 78b is provided for leaping into the concave portion 10c when the barrier 7 is fully opened. The engagement between the concave portion 10c and the claw 78b eliminates rattles of the lower barrier-end when the barrier 7 is fully opened, enabling a camera user to certainly hold the camera when the camera is gripped.

Next, the shape of the barrier 7 will be described. As shown in FIG. 5, the holding member 74, the gears 75, and the guide rail 10 substantially fall within the range of the vertical size of the lens, so that the barrier 7 according to the embodiment is substantially square in shape while covering almost the camera full height; however, it is not limited to the square shape and it may be circular or elliptical as long as the shape falls within the rack gears 71a to be mated with the gears 75 at minimum, thereby increasing the degree of design freedom.

A barrier mechanism according to the present invention, being movable between a closed position covering a lens barrel and an open position exposing the lens barrel, comprises guiding means for guiding the movement of a barrier disposed at a position covered with the barrier regardless of the movement of the barrier, a guide rail disposed in a camera body and extending in the barrier moving direction, and an engaging member disposed at a barrier open-side end to be engaged with the guide rail, thereby suppressing the looseness and backlash of the barrier without damaging design.

The restriction of the barrier-end position in the back and forth direction of the camera by the guide rail and the bent portion of the engaging member enables the barrier looseness to be suppressed.

The guiding means is constructed by the engagement between the rail member disposed on the barrier back surface and extending in the barrier movement direction and the holding member disposed at the barrier open-side end in the side of the barrel on the camera body, so that the exposure of the guide rail for guiding the barrier can be prevented.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A barrier mechanism of a camera comprising:
a camera body;
a barrier member being movable between a closed position covering a lens located in the front of the camera body and an open position exposing the lens;
a holding mechanism for holding the barrier member slidably between the closed position and the open position;
a guide rail member disposed in the camera body and extending in a sliding direction of the barrier member for guiding the barrier member; and
an engaging member disposed in the barrier member to be brought into engagement with the guide rail member.

2. A mechanism according to claim 1, wherein the holding mechanism comprises:
a guide plate disposed on the back surface of the barrier member; and
a holding member disposed in the camera body for slidably holding the barrier member by engaging with the guide plate.

3. A mechanism according to claim 2, wherein the holding member disposed in the camera body is located at a position covered with the barrier member even when the barrier member is positioned at any one of the closed position and the open position.

4. A mechanism according to claim 2, wherein the engaging member is disposed on the back surface of the barrier member and comprises a hook having a bent portion while the guide rail member having a slit groove to be brought into engagement with the bent portion of the hook.

5. A mechanism according to claim 2, wherein the holding mechanism further comprises a gear disposed in the camera body and a rack disposed in the barrier member to be mated with the gear.
